(19) United States
(12) Patent Application Publication
(10) Pub. No.: US 2024/0153222 A1
(43) Pub. Date: May 9, 2024

(54) SYSTEM AND METHOD FOR PROVIDING MULTIPLE PORTALS AS SEARCH RESULTS

(71) Applicant: PEER INC, Huntington Beach, CA (US)

(72) Inventor: Thinh Tran, Huntington Beach, CA (US)

(21) Appl. No.: 18/502,933

(22) Filed: Nov. 6, 2023

Related U.S. Application Data
(60) Provisional application No. 63/382,865, filed on Nov. 8, 2022.

(51) Int. Cl. G06T 19/00; G06F 3/04815; G06F 16/9538

(52) U.S. Cl. CPC G06T 19/006; G06F 3/04815; G06F 16/9538

(57) ABSTRACT

A method for providing augmented reality virtual portals as search results that are accessible to searchers. The method includes: receiving a search request from a searcher via a user input device; performing a search on the search request from the searcher; obtaining multiple search results on the search request from the searcher; calculating virtual representations of multiple physical spaces using captured images and measurements, the virtual representations of the multiple physical spaces corresponding to the multiple search results; creating a first portal in the multi-dimensional fabric user interface that connects to a first simulated space of the multiple simulated spaces, the first portal corresponding to a first search result from the multiple search results; and enable the searcher to pass through the first portal into the first simulated space that corresponds to the first search result from the multiple search results.

### BACKGROUND

### Technical Field

The present disclosure pertains to augmented reality virtual portals, and more particularly, to an augmented reality search engine system that provides virtual portals as search results.

### Description of the Related Art

Operating systems have changed little over the past few decades. Early operating systems were command driven, where a user specified a particular file location to access data. These operating systems morphed into the icon-based interfaces used today. Icon-based operating systems display graphical representations, or icons, of files or data. Icons are associated with a particular file location, such that interaction with an icon by a user results in the corresponding file location being accessed. Accordingly, historical operating systems have been structured around using the file's location within the memory to access data, which limits the flexibility of using alternative storage structures.

Additionally, there is a continuing desire to virtually visit actual physical locations that exist in the real world for a variety of purposes. This may be as basic as using a mapping software application. However, traditional mapping software is very limited in the information that it conveys and the user experience that it provides.

Furthermore, there is a continuing desire to improve methods of travel between virtual locations in an augmented reality virtual environment. The present disclosure addresses this and other needs.

### BRIEF SUMMARY

The present disclosure is directed towards augmented reality environments and/or virtual reality environments. Specifically, some aspects of the present disclosure are directed towards augmented reality environments and/or virtual reality environments that contain portals that may be created by users and are accessible by users.

Briefly stated, embodiments of the present disclosure are directed towards a system for providing augmented reality virtual portals as search results that are accessible to searchers. In some such embodiments, the system includes a remote server having a server memory that stores server computer instructions and a server processor. The server processor, when executing the server computer instructions, causes the remote server to: receive a search request from a searcher via a user input device; perform a search on the search request from the searcher; obtain multiple search results on the search request from the searcher; and calculate virtual representations of multiple physical spaces using captured images and measurements, the virtual representations of the multiple physical spaces corresponding to the multiple search results. Additionally, the system creates a first portal in a multi-dimensional fabric user interface that connects to a first simulated space of multiple simulated spaces. This first portal corresponds to a first search result from the multiple search results. The first portal has an initial side and a first simulated space side. The system also enables the searcher to access the first portal in the multi-dimensional fabric user interface to interact with the first simulated space.

Further, the system creates a second portal in the multi-dimensional fabric user interface that connects to a second simulated space of the multiple simulated spaces. The second portal corresponds to a second search result from the multiple search results. The second portal has an initial side and a second simulated space side. The system also enables the searcher to access the second portal in the multi-dimensional fabric user interface to interact with the second simulated space. Moreover, the system enables the searcher to look through one or more of the first portal and the second portal, and interact with one or more other users, virtual objects, virtual locations, or virtual events in one or more of the first simulated space and the second simulated space while the searcher remains on the initial side of the first portal and the initial side of the second portal.

In some embodiments of the system for providing augmented reality virtual portals as search results that are accessible to searchers, the server processor executes further server computer instructions that further cause the remote server to: create a third portal in the multi-dimensional fabric user interface that connects to a third simulated space of the multiple simulated spaces, the third portal corresponding to a third search result from the multiple search results, the third portal having an initial side and a second simulated space side; enable the searcher to access the third portal in the multi-dimensional fabric user interface to interact with the third simulated space; and enable the searcher to look through the third portal, and interact with one or more other users, virtual objects, virtual locations, or virtual events in the third simulated space while the searcher remains on the initial side of the third portal and the initial side of the second portal.

In another aspect of some embodiments, the server processor executes further server computer instructions that further cause the remote server to: enable the searcher to enter the first portal and travel to the first simulated space from the multi-dimensional fabric user interface and enter the second portal and travel to the second simulated space from the multi-dimensional fabric user interface. In still another aspect of some embodiments, the server processor executes further server computer instructions that further cause the remote server to: while in the first simulated space or the second simulated space, enable the searcher to interact with one or more other users, virtual objects, virtual locations, or virtual events in the first simulated space or the second simulated space.

In one or more embodiments of the system for providing augmented reality virtual portals as search results that are accessible to searchers, the captured images and measurements of a physical space is captured by one or more hardware sensor arrays, wherein the one or more hardware sensor arrays uses LIDAR to capture one or more flat images and images with depth resolution. In another aspect of some embodiments, the server processor executes further server computer instructions that further cause the remote server to enable the searcher to control parameters within the simulated space. In still another aspect of some embodiments, one of the parameters within the simulated space that is controllable by the searcher is time, and wherein the searcher can speed up or slow down a rate at which time passes. In yet another aspect of some embodiments, the remote server when executing the server computer instructions further causes the remote server to: enable the searcher to move from the first simulated space to the second simulated space through an additional portal.

In other embodiments, the present disclosure is directed towards one or more methods for providing augmented reality virtual portals as search results that are accessible to searchers. The method includes: accessing a remote server that includes a server memory that stores server computer instructions and a server processor that executes the server computer instructions; receiving a search request from a searcher via a user input device; performing a search on the search request from the searcher; obtaining multiple search results on the search request from the searcher; calculating virtual representations of multiple physical spaces using captured images and measurements, the virtual representations of the multiple physical spaces corresponding to the multiple search results; creating a first portal in a multi-dimensional fabric user interface that connects to a first simulated space of multiple simulated spaces, the first portal corresponding to a first search result from the multiple search results, the first portal having an initial side and a first simulated space side; enabling the searcher to access the first portal in the multi-dimensional fabric user interface to interact with the first simulated space; creating a second portal in the multi-dimensional fabric user interface that connects to a second simulated space of the multiple simulated spaces, the second portal corresponding to a second search result from the multiple search results, the second portal having an initial side and a second simulated space side; enabling the searcher to access the second portal in the multi-dimensional fabric user interface to interact with the second simulated space; and enabling the searcher to look through one or more of the first portal and the second portal, and interact with one or more other users, virtual objects, virtual locations, or virtual events in one or more of the first simulated space and the second simulated space while the searcher remains on the initial side of the first portal and the initial side of the second portal.

In some embodiments of the method for providing augmented reality virtual portals as search results that are accessible to searchers, the method further includes: creating a third portal in the multi-dimensional fabric user interface that connects to a third simulated space of the multiple simulated spaces, the third portal corresponding to a third search result from the multiple search results, the third portal having an initial side and a second simulated space side; enabling the searcher to access the third portal in the multi-dimensional fabric user interface to interact with the third simulated space; and enabling the searcher to look through the third portal, and interact with one or more other users, virtual objects, virtual locations, or virtual events in the third simulated space while the searcher remains on the initial side of the third portal and the initial side of the second portal.

In another aspect of some embodiments, the method further includes enabling the searcher to enter the first portal and travel to the first simulated space from the multi-dimensional fabric user interface and enter the second portal and travel to the second simulated space from the multi-dimensional fabric user interface. In still another aspect of some embodiments, the method further includes: while in the first simulated space or the second simulated space, enabling the searcher to interact with one or more other users, virtual objects, virtual locations, or virtual events in the first simulated space or the second simulated space.

In one or more embodiments of the method for providing augmented reality virtual portals as search results that are accessible to searchers, the captured images and measurements of a physical space is captured by one or more hardware sensor arrays, wherein the one or more hardware sensor arrays uses LIDAR to capture one or more flat images and images with depth resolution. In another aspect of some embodiments, the method further includes enabling the searcher to control parameters within the simulated space. In still another aspect of some embodiments, one of the parameters within the simulated space that is controllable by the searcher is time, and wherein the searcher can speed up or slow down a rate at which time passes. In yet another aspect of some embodiments, the method further includes enabling the searcher to move from the first simulated space to the second simulated space through an additional portal.

In another embodiment of the system for providing augmented reality virtual portals as search results that are accessible to searchers, the system includes a remote server that includes a server memory that stores server computer instructions and a server processor. The server processor, when executing the server computer instructions, causes the remote server to: receive a search request from a searcher via a user input device; perform a search on the search request from the searcher; obtain multiple search results on the search request from the searcher; and calculate virtual representations of multiple physical spaces using captured images and measurements, the virtual representations of the multiple physical spaces corresponding to the multiple search results.

Additionally, the system creates a first portal in a multi-dimensional fabric user interface that connects to a first simulated space of multiple simulated spaces. The first portal corresponding to a first search result from the multiple search results. The system also enables the searcher to access the first portal in the multi-dimensional fabric user interface to enter the first simulated space. Further, the system creates a second portal in the multi-dimensional fabric user interface that connects to a second simulated space of the multiple simulated spaces. The second portal corresponding to a second search result from the multiple search result. The system also enables the searcher to access the second portal in the multi-dimensional fabric user interface to enter the second simulated space. Moreover, the system enables the searcher to pass through the first portal into the first simulated space that corresponds to the first search result from the multiple search results, and pass through the second portal into the second simulated space that corresponds to the second search result from the multiple search results.

In another aspect of some embodiments, the server processor executes further server computer instructions that further cause the remote server to: create a third portal in the multi-dimensional fabric user interface that connects to a third simulated space of the multiple simulated spaces, the third portal corresponding to a third search result from the multiple search results; and enable the searcher to pass through the third portal in the multi-dimensional fabric user interface to the third simulated space that corresponds to the third search result from the multiple search results.

In still another aspect of some embodiments, the server processor executes further server computer instructions that further cause the remote server to: enable the searcher to interact with one or more other users, virtual objects, virtual locations, or virtual events in the first simulated space or the second simulated space, while in the first simulated space or the second simulated space. In yet another aspect of some embodiments, the remote server when executing the server computer instructions further causes the remote server to enable the searcher to move from the first simulated space to the second simulated space through an additional portal.

In another embodiments of the method for providing augmented reality virtual portals as search results that are accessible to searchers, the method includes: receiving a search request from a searcher via a user input device; performing a search on the search request from the searcher; obtaining multiple search results on the search request from the searcher; calculating virtual representations of multiple physical spaces using captured images and measurements, the virtual representations of the multiple physical spaces corresponding to the multiple search results; creating a first portal in a multi-dimensional fabric user interface that connects to a first simulated space of multiple simulated spaces, the first portal corresponding to a first search result from the multiple search results, the first portal having an initial side and a first simulated space side; enabling the searcher to access the first portal in the multi-dimensional fabric user interface to enter the first simulated space; creating a second portal in the multi-dimensional fabric user interface that connects to a second simulated space of the multiple simulated spaces, the second portal corresponding to a second search result from the multiple search results, the second portal having an initial side and a second simulated space side; enabling the searcher to access the second portal in the multi-dimensional fabric user interface to enter the second simulated space; and enable the searcher to pass through the first portal into the first simulated space that corresponds to the first search result from the multiple search results, and pass through the second portal into the second simulated space that corresponds to the second search result from the multiple search results.

In another aspect of some embodiments, the method further includes: creating a third portal in the multi-dimensional fabric user interface that connects to a third simulated space of the multiple simulated spaces, the third portal corresponding to a third search result from the multiple search results, the third portal having an initial side and a second simulated space side; and enabling the searcher to pass through the third portal in the multi-dimensional fabric user interface to the third simulated space that corresponds to the third search result from the multiple search results.

In still another aspect of some embodiments, the method further includes: while in the first simulated space or the second simulated space, enabling the searcher to interact with one or more other users, virtual objects, virtual locations, or virtual events in the first simulated space or the second simulated space. In another aspect of some embodiments, the method further includes: enabling the searcher to move from the first simulated space to the second simulated space through an additional portal.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings:

FIG. 1 illustrates a context diagram of an environment that provides a multi-dimensional fabric user interface for storing content in accordance with embodiments described herein;

FIG. 2 illustrates a graphical representation of a multi-dimensional fabric user interface for storing content in accordance with embodiments described herein;

FIG. 3 illustrates a logical flow diagram generally showing one embodiment of a process for accessing a remote server from a display device to present a graphical user interface of a multi-dimensional fabric user interface in accordance with embodiments described herein;

FIG. 4 illustrates a logical flow diagram generally showing one embodiment of a process for a remote server to provide a graphical user interface of a multi-dimensional fabric user interface to a display device in accordance with embodiments described herein;

FIG. 5 illustrates a hardware sensor array that is used to capture images and measurements of a physical space that may be represented as a simulated space;

FIG. 6 illustrates an augmented reality search engine system for enabling portal functionality in a multi-dimensional fabric user interface;

FIG. 7 illustrates a virtual representation of the multiple portals being provided as search results in response to the search request;

FIG. 8A illustrates a first portal of multiple portals provided as search results being accessed by a searcher;

FIG. 8B illustrates a first simulated space accessed through the first portal of multiple portals by the searcher;

FIG. 9A illustrates a second portal of multiple portals provided as search results being accessed by the searcher;

FIG. 9B illustrates a second simulated space accessed through the second portal of multiple portals by the searcher;

FIG. 10A illustrates a third portal of multiple portals provided as search results being accessed by the searcher;

FIG. 10B illustrates a third simulated space accessed through the third portal of multiple portals by the searcher;

FIG. 11 illustrates a logic diagram showing a searcher accessing multiple portals that are the search results of a search request by the searcher; and

FIG. 12 illustrates a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the automobile environment, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” includes singular and plural references. As used herein, the terms “user” and “searcher” are used interchangeably.

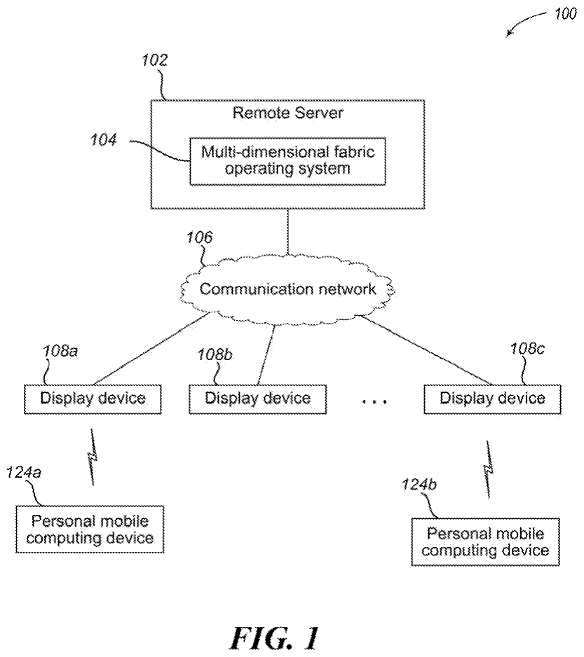

FIG. 1 illustrates a context diagram of an augmented reality search engine system for providing multiple portals as search results in a multi-dimensional fabric user interface that are accessible to a user inputting search requests, in accordance with embodiments described herein. In the illustrated example, environment 100 includes a remote server 102, one or more display devices 108a-108c, and one or more personal mobile computing devices.

The remote server 102 in the augmented reality search engine system for providing multiple portals as search results in a multi-dimensional fabric user interface is configured as a remote computing system, e.g., cloud computing resources, which implements or executes a multi-dimensional fabric operating system 104. In various embodiments, a separate instance of the multi-dimensional fabric operating system 104 is maintained and executed for each separate personal mobile computing device 124a, 124b. In some embodiments, the multi-dimensional fabric user interface may be implemented as an operating shell.

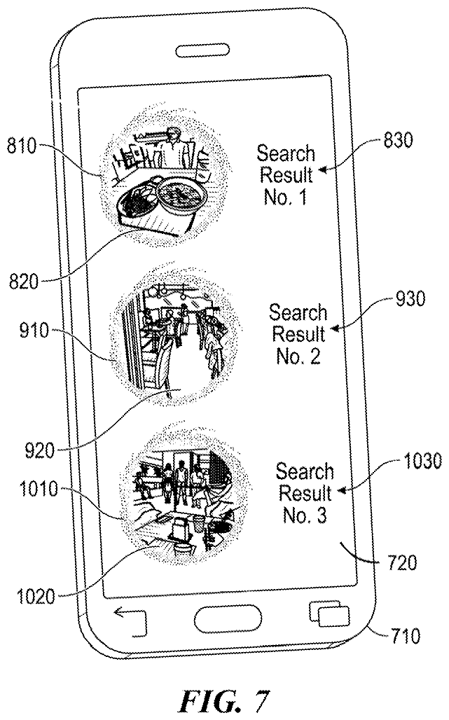

Additionally, the remote server 102 has a server memory that stores server computer instructions, and a server processor that executes the server computer instructions and causes operations, such as those described herein, to be executed. In some embodiments, the remote server 102 creates simulated spaces (shown in FIG. 7) in the multi-dimensional fabric user interface representing search results that are accessed by virtual portals (shown in FIG. 7). The simulated spaces are displayed on a display device 108 or personal mobile computing device 124.

Although not illustrated, the remote server 102 may also be running various programs that are accessible to the users of the personal mobile computing devices 124a, 124b via the multi-dimensional fabric operating system 104. Accordingly, the environment and system described herein make it possible for a plurality of applications to be run in the cloud, and a user accesses a particular application by moving the fabric to that application's coordinates.

The multi-dimensional fabric operating system 104 in the augmented reality search engine system for providing multiple portals as search results accesses stored content according to a plurality of different dimensions. In some embodiments, the stored content is accessed based on when the content was captured by the user or when it was stored by the remote server 102 (e.g., a time stamp added to a picture when the picture was captured or a time stamp when the picture was uploaded to the remote server), where the content was captured by the user (e.g., the location of the camera that captured the picture or a location of a display device used to upload the picture from the camera to the remote server), and what the content is about (e.g., food, clothing, entertainment, transportation, etc.).

A user in the augmented reality search engine system for providing multiple portals as search results in a multi-dimensional fabric user interface can input search requests using an input device and “visit” search results by accessing the search results (i.e., augmented reality simulated spaces) through one or more of the multiple portals provided in response to the search request. The user has a personal mobile computing device 124 which can create or obtain content. The user can walk up to or approach a display device 108. The display device 108 coordinates authentication of the personal mobile computing device 124 with the remote server 102. The user can then use the display device 108 as a personal computer to upload content from the personal mobile computing device 124 to the remote server 102 using the multi-dimensional fabric operating system 104. Similarly, the user can use the display device 108 to access content previously stored by the multi-dimensional fabric operating system 104. For example, the user can use hand gestures, or touch interfaces, to provide input that manipulates a user interface displayed on the display device 108, where the user interface is generated by the multi-dimensional fabric operating system 104. The remote server 102 can respond to the input by providing an updated user interface of the multi-dimensional fabric to the display device 108 for display to the user. Notably, the user may transmit between the personal mobile computing device 124b and the remote server 102 via the communication network 106, without connecting to a display device 108 in some embodiments.

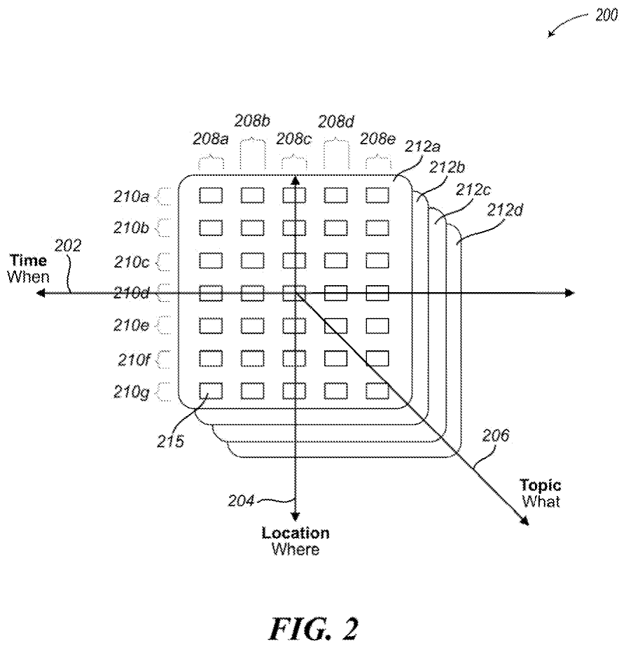

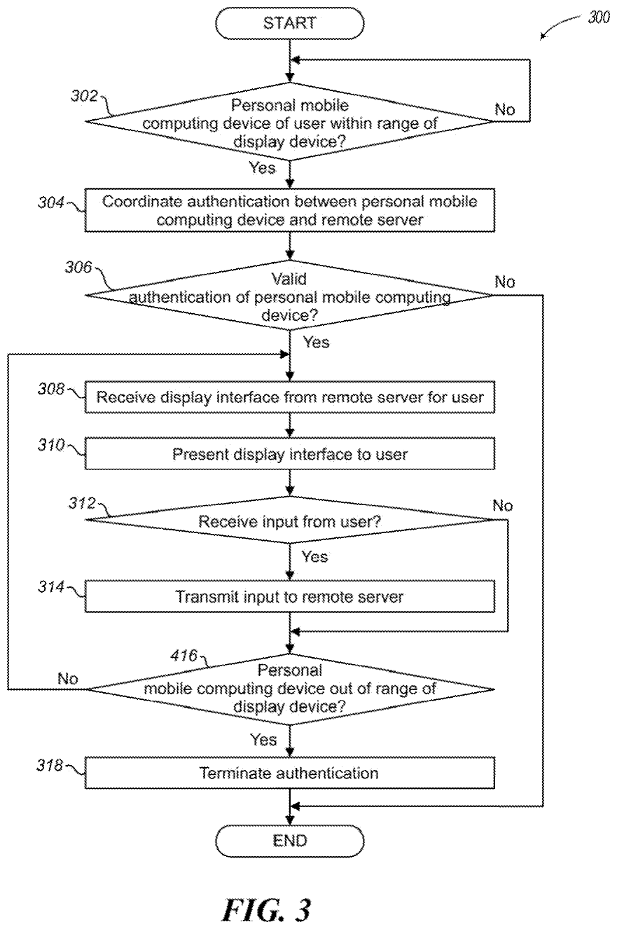

FIGS. 2 and 3 illustrate graphical representations of use case examples of an augmented reality search engine system for providing multiple portals as search results in a multi-dimensional fabric user interface as described herein.

Example fabric 200 in FIG. 2 includes a time axis 202, a location axis 204, and a topic axis 206. Although fabric 200 appears to be constrained in each axis, embodiments are not so limited. Rather, fabric or graphical environment is flexible, while the coordinate is fixed. This allows a user to use cruder movements, like the swipe of an arm, to achieve refined movement to arrive at the content. This also reduces the content footprint because it does not need to manage a file structure, which improves throughput to a degree that it can run entirely in the cloud.

In some embodiments, users in the multi-dimensional fabric system navigate by moving the environment, or fabric, to a specific content or item. The content is placed within a 3-dimensional structure of Time (when)+Location (where)+Topic (what), which may be in the form of a multi-dimensional coordinate system. By configuring the content in the fabric based on 3 dimensions (What, When, Where), the fabric provides a pre-configured scaffold that allows a user to navigate the plurality of content without the multi-dimensional fabric system fetching and organizing it. The fabric makes discovering more relevant content immediately accessible.

The time axis 202 in the multi-dimensional fabric system may be arranged as a plurality of different time periods, such as hours or days. In various embodiments, the current time period (e.g., today) is shown in the middle column 208c, which is shown in FIG. 3. The location axis 204 may be arranged as a plurality of different locations. In some embodiments, the content locations are selected based on a distance from a current location of the display device that is accessing the fabric 200. For example, locations closest to the display device are arranged in the top column 210a and the locations furthest from the display device are arranged in the bottom column 210g. Likewise, topics may be arranged based on themes or nearest to the display device. For example, food content may be in layer 212a, entertainment content in layer 212b, transportation content in layer 212c, etc. In other embodiments, the topics may be arranged based on frequency of access to the user based on location.

The fabric 200 in the multi-dimensional fabric system illustrates a plurality of icons 215 where each represents separate content (also referred to as content 215). The content 215 is laid out in a plurality of time periods 208a-208e (columns), a plurality of locations 210a-210g (rows), and a plurality of topics 212a-212d (layers), using coordinates associated with the separate dimensions. For any given point defined by (What, When, Where) there is a finite amount of content or data. As a result, users can simply point out a certain What, When, and Where to know where something is located and can directly access it from that point.

In some embodiments of the augmented reality search engine system for providing multiple portals as search results in a multi-dimensional fabric user interface, the location rows 210a-210g, time columns 208a-208e, and topic layers 212a-212d may be independent from one another such that a user can manipulate a single axis. In other embodiments, the user can manipulate two or more axes. For example, a user can vertically scroll along the location axis 204 through a single column (e.g., single time period on the time axis), such as column 208c, without affecting the other columns or layers, or the user can vertically scroll along the location axis 204 for multiple columns or multiple layers, or both. Likewise, the user can horizontally scroll along the time axis 202 through a single row (e.g., single location on the location axis), such as row 210d, without affecting the other rows or layers, or the user can horizontally scroll along the time axis 202 for multiple rows or multiple layers, or both. Moreover, the user can depth scroll along the topic axis 206 through a single layer (e.g., single topic on the topic axis), such as layer 212a, without affecting the other rows or columns, or the user can depth scroll along the topic axis 206 for multiple rows or multiple columns, or both.

By providing input to one or more axes in the augmented reality search engine system for providing multiple portals as search results in a multi-dimensional fabric user interface, the user can manipulate or move the fabric 200 to access content for a specific time, a specific location, and a specific topic. The user can scroll on a particular axis by providing one or more hand gestures. For example, a horizontal movement of the user's arm may move the time axis 202, a vertical movement of the user's arm may move the location axis 204, and an in-or-out movement of the user's arm may move the topic axis 206. The user can then select a specific content 215, such as the content in the middle (along time and location axes) and on top (along the topic axis) of the fabric by moving their arm away from the display screen or by making a first or by opening their hand.

In some embodiments of the augmented reality search engine system for providing multiple portals as search results in a multi-dimensional fabric user interface, the fabric will look two dimensional to a user, but is actually three dimensional, such that when a two-dimensional point is selected by the user, the user can switch axes to view the third dimension. And although FIG. 2 shows the time axis 202 and the location axis 204 on this top-level two-dimensional view, other combinations of axes may also be used, e.g., time v. topic, location v. topic, or other non-illustrated axes.

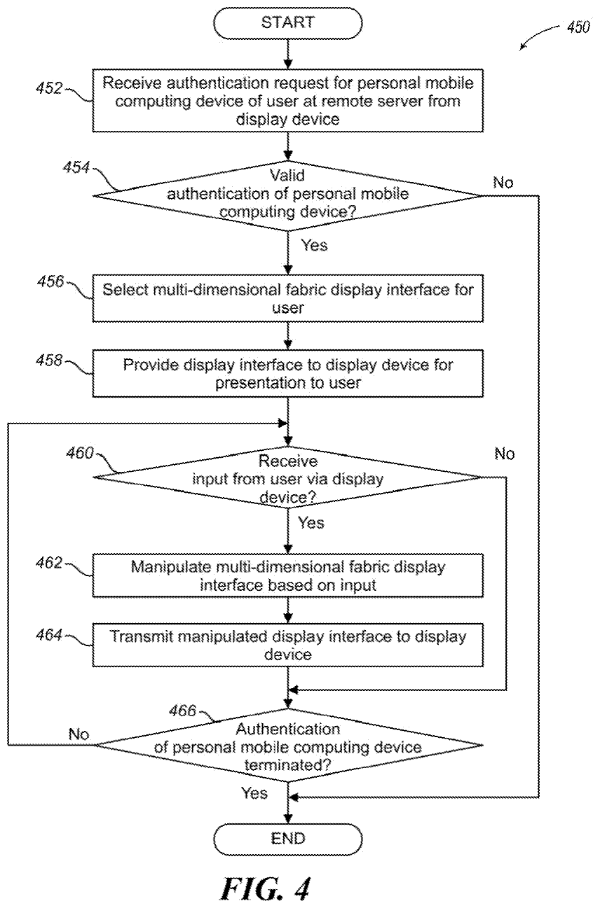

The operation of certain aspects of the disclosure will now be described with respect to FIGS. 3 and 4. In at least one of various embodiments of the augmented reality search engine system for providing multiple portals as search results in a multi-dimensional fabric user interface, process 300 described in conjunction with FIG. 3 may be implemented by or executed by a system of one or more computing devices, such as display device 108 in FIG. 1, and process 450 described in conjunction with FIG. 4 may be implemented by or executed by a system of one or more remote computing devices, such as remote server 102.

FIG. 3 illustrates a logical flow diagram generally showing one embodiment of a process 300 for accessing a remote server from a display device to present a graphical user interface of a multi-dimensional fabric in accordance with embodiments described herein. In some embodiments, authentication is performed between the personal mobile computing device and a remote server. In other embodiments of the augmented reality search engine system for providing multiple portals as search results in a multi-dimensional fabric user interface, a different authentication system may be employed. In still other embodiments of the augmented reality search engine system for providing multiple portals as search results in a multi-dimensional fabric user interface, no authentication system is employed.

Process 300 begins, after a start block, at decision block 302, where a determination is made whether a personal mobile computing device of a user is within range of the display device. This determination may be made when the personal mobile computing device is within a threshold distance from the display device (e.g., using one or more range detection devices) or when the user indicates or requests to interact with the display device. If the personal mobile computing device is within range of the display device, then process 300 flows to block 304; otherwise process 300 loops to decision block 302 until a personal mobile computing device is within range of the display device.

At block 304, the display device coordinates authentication between the personal mobile computing device and a remote server. This coordination may include obtaining, requesting, or otherwise forwarding authentication keys or other information to determine the validity or authenticity of the personal mobile computing device as being authorized to access the remote server.

Process 300 proceeds to decision block 306, where a determination is made whether the personal mobile computing device is validly authenticated with the remote server. In some embodiments, the remote server may provide a token, session identifier, or other instruction to the display device indicating that the user of the personal mobile computing device is authorized to access the remote server via the display device. If the personal mobile computing device is valid, then process 300 flows to block 308; otherwise, process 300 terminates or otherwise returns to a calling process to perform other actions.

At block 308, the display device receives a display interface from the remote server for the user. In various embodiments, the display interface is customized for the user, such as if the user logged directly onto the remote server to access personal content. As described herein, this display interface is a multi-directional fabric that the user can manipulate, as described herein.

Process 300 continues at block 310, where the display device presents the display interface to the user of the personal mobile computing device. In some embodiments, the display interface is displayed directly by the display device. In other embodiments, the display interface is displayed via the personal mobile computing device.

Process 300 proceeds next to decision block 312, where a determination is made whether the display device has received input from the user. As described herein, the input may be provided via a hand gesture without touching a screen of the display device. Such hand gesture may be a swipe left or right, swipe up or down, or movement towards or away from the screen of the display device. A selection input can then be received if the user rapidly moves their hand away from the screen of the display device or if the user opens or closes his/her hand. If user input is received, then process 300 flows to block 314; otherwise, process 300 flows to decision block 316.

At block 314, the display device transmits the user input to the remote server. Process 300 proceeds to decision block 316, where a determination is made whether the personal mobile computing device is out of range of the display device (e.g., outside of a threshold distance or the user de-activated the session). If not, process 300 loops to block 308 to receive an updated or modified display interface (based on the user input) and present it to the user. If the personal mobile computing device is out of range of the display device, then process 300 flows to block 318 to terminate the authentication with the remote server. After block 318, process 300 may terminate or otherwise return to a calling process to perform other actions. In some embodiments, process 300 may loop to decision block 302 to wait for another personal mobile computing device to be within range of the display device.

FIG. 4 illustrates a logical flow diagram generally showing one embodiment of a process 450 in the augmented reality search engine system for providing multiple portals as search results in a multi-dimensional fabric user interface for a remote server to provide a graphical user interface of a multi-dimensional fabric to a display device in accordance with embodiments described herein.

Process 450 begins, after a start block, at block 452, where an authentication request is received at a remote server from a display device for a personal mobile computing device of a user. In some embodiments, the authentication request may include encryption keys, user credentials, or other authentication information. Process 450 proceeds to decision block 454, where a determination is made whether the personal mobile computing device is validly authenticated or not. If the personal mobile computing device is valid, process 450 flows to block 456; otherwise, process 450 terminates or otherwise returns to a calling process to perform other actions.

At block 456, the remote server selects a multi-dimensional fabric display interface for the user of the personal mobile computing device. In some embodiments, the remote server instantiates or accesses a previously running version of the multi-dimensional fabric operating system for the user. In various embodiments, each separate user (or a group of multiple users) has a corresponding multi-dimensional fabric user interface accessible via the remote server. The multi-dimensional fabric display interface with content laid out in a fabric-like structure is based on at least time, location, and topic such that the user can manipulate or move the fabric in one or more dimensions to select content.

Process 450 proceeds to block 458, where the remote server provides the selected display interface to the display device for presentation to the user. Process 450 continues at decision block 460, where a determination is made whether user input has been received from the display device. In various embodiments, the input may be a change or selection of one or more dimensions of the fabric or a user selection. If user input has been received, process 450 flows to block 462; otherwise, process 450 flows to decision block 466.

At block 462, the remote server manipulates the multi-dimensional fabric display interface based on the user input. In some embodiments, the manipulated display interface may include displaying specific content selected by the user. In other embodiments, the manipulated display interface may show a different section or area of the multi-dimensional fabric user interface based on the user input.

Process 450 proceeds next to block 464, where the remote server transmits the manipulated display interface to the display device. Process 450 continues next at decision block 466, where a determination is made whether the authentication of the personal mobile computing device has terminated. In some embodiments, the display device transmits a termination request to the remote server when the user of the personal mobile computing device walks away from or is out of range of the display device. If the authentication is terminated, process 450 terminates or otherwise returns to a calling process to perform other actions; otherwise, process 450 loops to decision block 460 to receive additional user input from the display device.

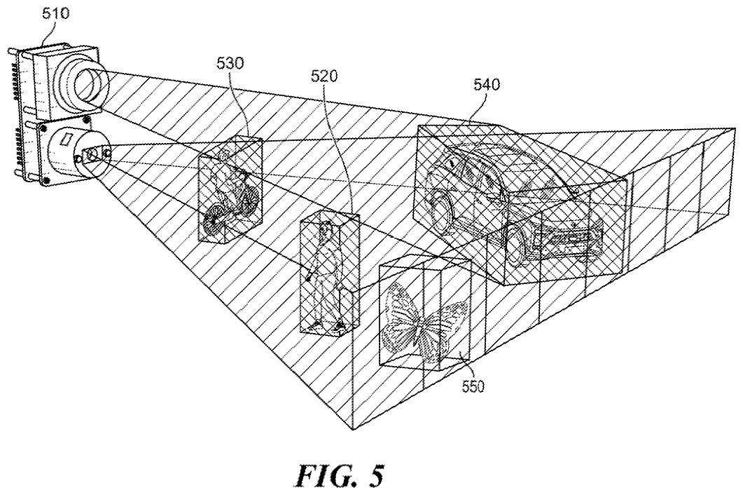

Referring now to FIG. 5, the hardware sensor array 510 is shown for the augmented reality search engine system that provides multiple portals as search results in a multi-dimensional fabric user interface. Specifically, in FIG. 5 a hardware sensor array 510 is shown that is used to capture images and measurements of a physical space that may be represented as a simulated space that is associated with a search result and accessed via a portal. The hardware sensor array 510 may also be used to capture images and measurements of people 520, bicycles 530, automobiles 540, animals 550, or other objects that may be loaded into the simulated space. Additionally, in some embodiments multiple physical spaces are captured (e.g., images, measurements, and location data) by the hardware sensor array 510, and then linked together on a search result page such that each of the multiple simulated spaces are associated with a corresponding search result and accessed via a corresponding portal.

In other aspects of some embodiments, multiple physical spaces are captured by the hardware sensor array, and various aspects or portions of the multiple physical spaces are merged into a single simulated space. In still other aspects of some embodiments, multiple physical spaces are captured by the hardware sensor array and saved as distinct alternate simulated spaces.

In some embodiments, the hardware sensor array 510 includes one or more imaging sensors, 3D sensors, LIDAR (light detection and ranging) sensors, SONAR (sound navigation ranging) sensors, RADAR (radio detection and ranging) sensors, infrared sensors, proximity sensors, Ultrasonic sensors, time of flight sensors, and other sensors. In some such sensors, the hardware sensor array 510 captures one or more flat images. While in other embodiments, the hardware sensor array 510 captures one or more images with depth resolution. Thus, the hardware sensor array 510 may be used to obtain the information (e.g., images, measurements, and the like) used to create a virtual representation of the physical space that may be represented as a simulated space, i.e., representing a search result that is accessed by a portal.

The image sensors are sensors that detect and convey information used to make an image. These sensors do so by converting the light waves into signals that convey the information. The waves can be light or other electromagnetic radiation. The ranging sensors are sensors that detect distance to the target of interest. By determining the distance to the target of interest, the size of the target of interest may be determined and used to size the images in proper proportion.

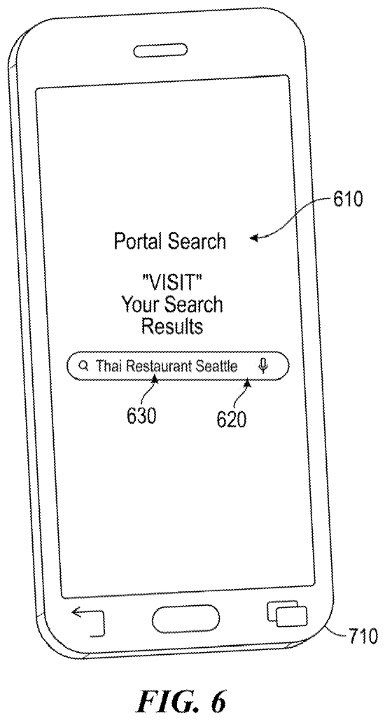

As shown in FIG. 6, in one or more embodiments of the augmented reality search engine system for providing multiple portals as search results, a portal search home page 610 is shown. The portal search home page 610 includes a search bar 620 for inputting a user search request 630. In some embodiments, a microphone button is included in the search bar 620 that facilitates audio search requests to be input by a user. In the embodiment shown in FIG. 6, the user search request 630 entered into the search bar 620 is the terms “Thai Restaurant Seattle.” In some such embodiments, when the user selects to enter the search bar 620 with a cursor, an alpha-numeric pop-up box (not shown) is presented that enables a user to enter the user search request terms. The user then selects an “enter” function to execute the search using the search terms in the search bar 620. In some embodiments, initial user search request terms may be automatically added to the search bar 620. These initial user search request terms may be selected based on previous user searches, a current location of the user, preferences of the user, content filters, or current social media posts.

In a traditional search engine, a search request produces search results that each include text and a hyperlink to a webpage. In this manner, traditional search engines are searchable databases of web content that include a search index and one or more search algorithms. A search index is a digital library of information about webpages, and a search algorithm is a computer program that matches results from the search index. Typically, a search engine uses web crawlers (e.g., spiders or bots) to “crawl” i.e., (visit a web page and copy its content and links) million or billions of webpages and navigate the web to find new webpages. These webpages are added to the search index from which the search engines pulls results. The search engine can also invite site owners request crawling of individual URLs. However, in the augmented reality search engine system for providing multiple portals as search results, multiple virtual portals are presented as the search results in response to the execution of the search request. Thus, the search index of the augmented reality search engine system includes simulated spaces that are accessible by a virtual portals, instead of only webpages as found in traditional search engines.

Referring now to FIG. 7, an augmented reality search engine system for providing multiple portals as search results on a search results page 720 is shown in which multiple portals 810, 910, and 1010 are presented as search results in response to the user search request 630 input in FIG. 6. Specifically, in this embodiment shown in FIG. 7, the augmented reality search engine system provides multiple portals 810, 910, and 1010 as search results 830, 930, and 1030 on the search results page 720, which enable the user of the augmented reality search engine system to travel to simulated spaces 820, 920, 1020. Otherwise stated, search result number one 830 includes a written explanation of the first search result (e.g., name of a first Thai Restaurant in Seattle, address of the first Thai Restaurant in Seattle, etc.), as well as a first result virtual portal 810 that provides an “entrance” for the user to enter the simulated space 820 associated with the first search result. Additionally, search result number two 930 includes a written explanation of the second search result (e.g., name of a second Thai Restaurant in Seattle, address of the second Thai Restaurant in Seattle, etc.), as well as a second result virtual portal 910 that provides an “entrance” for the user to enter the simulated space 920 associated with the second search result. Continuing, search result number three 1030 includes a written explanation of the third search result (e.g., name of a third Thai Restaurant in Seattle, address of the third Thai Restaurant in Seattle, etc.), as well as a third result virtual portal 1010 that provides an “entrance” for the user to enter the simulated space 1020 associated with the third search result.

In another embodiment of the augmented reality search engine system, one or more of the search results are accessed through a single portal which the user can enter and then see other, related portals, all of which connect to associated simulated spaces. In this manner, these related portals provide a cluster of results. For example, in one embodiment, in the search results provided in response to the search request for “Thai Restaurant in Seattle,” one of the results may be a portal that enables the user to see other search result portals for Thai restaurants in neighborhoods within Seattle (e.g., Belltown), cities adjacent to Seattle (e.g., Bellevue), or both. In still another embodiment, the search results provided in response to the search request for “Thai Restaurant in Seattle” are presented as a map that has various portals positioned at the geographically appropriate locations (i.e., addresses) of the search results (e.g., restaurants) on the map.

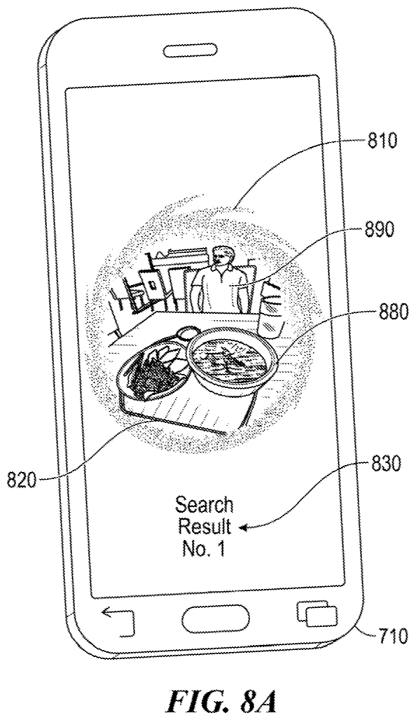

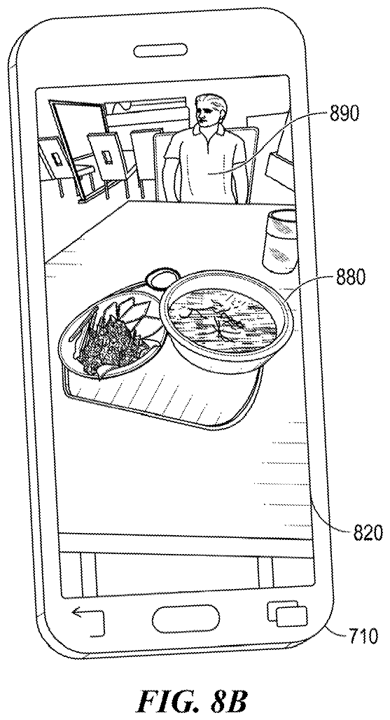

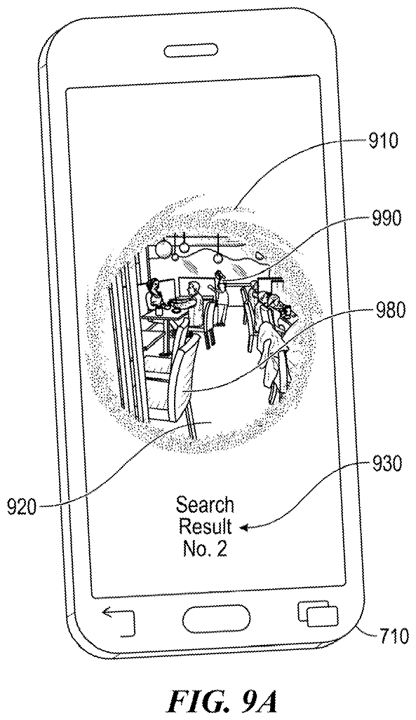

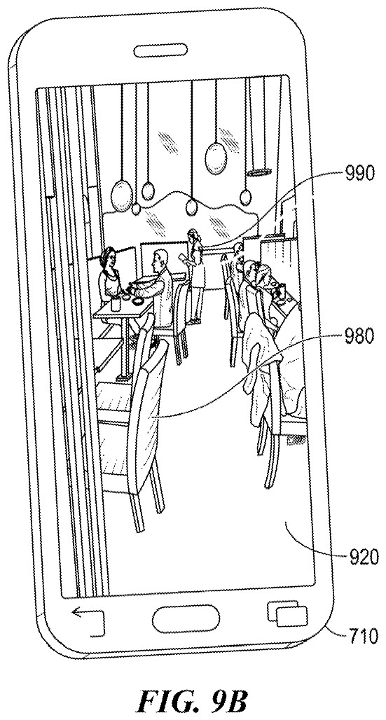

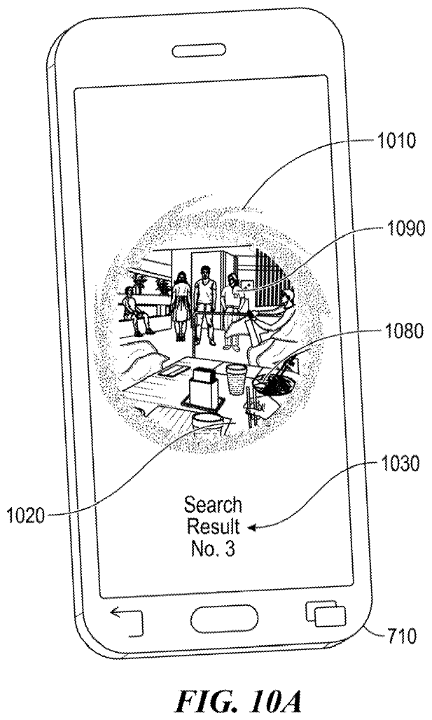

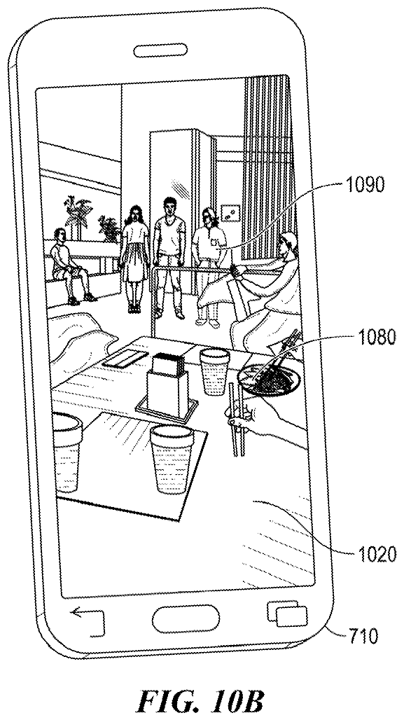

In some embodiments of the augmented reality search engine system, only one or two virtual portals are shown as search results. In other embodiments of the augmented reality search engine system, 4, 5, 10, 100, 200, 1000, or any intervening number of virtual portals are shown as search results. In some embodiments, when the user selects search result number one 830, they will be presented with FIGS. 8A and 8B, when the user selects search result number two 930, they will be presented with FIGS. 9A and 9B, and when the user selects search result number three 1030, they will be presented with FIGS. 10A and 10B. In some embodiments, the server 102 is used to create the simulated spaces and the associated portals, while is other embodiments, it is the user devices 124 that create the simulated spaces 820, 920, 1020 and the associated portals 810, 910, and 1010.

FIG. 8A illustrates a first portal 810 of the multiple portals provided as a search result of the augmented reality search engine system that is accessible by the user. The first portal 810 of the multiple portals provides an entrance to the first simulated space 820, which is a result search of the user search request 630 that was entered into the search bar 620 in FIG. 6. Inside the first simulated space 820 (through the portal 810), virtual items 880 such as virtual foods 880 are shown in the current embodiment. Additionally, inside the first simulated space 820 (through the portal 810), virtual people 890 are shown, which may be other users (i.e., avatars of other users), may be virtual non-user characters, or both, in the current embodiment.

In one or more embodiments, such as those disclosed in FIG. 8A, the first portal 810 may enable a user to look through the first portal 810 in the multi-dimensional fabric user interface and see the first simulated space 820 on the other side of the first portal 810, using a personal mobile computing device 710. Thus, in the embodiment shown in FIG. 8A, the user is able to look through the first portal 810 and see the virtual representation of the first search result 830 (i.e., the virtual representation of the physical space) in the simulated space 820 on the other side of the first portal 810, using a personal mobile computing device 710. In still other embodiments, the user may not be able to initially see through the first portal 810 and see the virtual representation of the first search result 830 (i.e., the virtual representation of the physical space) in the first simulated space 820 on the other side of the first portal 810 until after the user takes a certain action or initiates a certain operation to cause the first portal 810 to become open as a viewing port.

Moreover, in one or more embodiments, the augmented reality search engine system for providing multiple portals as search results in a multi-dimensional fabric user interface enables the user to look through the first portal 810 associated with the first search result 830, as shown in FIG. 8A, and see a virtual person 890 or another user in the first simulated space 820, which is a virtual representation of physical space associated with the first search result 830 in the multi-dimensional fabric user interface. In some such embodiments, the augmented reality search engine system enables the user to look through the first portal 810 associated with the first search result 830 and interact with one or more virtual persons 890 (potentially including other users), virtual objects 880, virtual locations, or virtual events in the first simulated space 820 associated with the first search result 830, while still remaining on the search results page 720. Such interaction through the first portal 810 is similar to the action of a customer interacting with a vender through a service window. These interactions include by way of example only, and not by way of limitation: uploading data, downloading data, posting data, live streaming data, purchasing a product or service, selling a product or service, anchoring digital content to the multi-dimensional fabric, and modifying previously anchored digital content on the multi-dimensional fabric.

FIG. 8B illustrates a first simulated space 820 accessed through the first portal 810 of multiple portals that is associated with the first search result 830 by the searcher. Referring now to FIG. 8B, in some aspects of the augmented reality search engine system for providing multiple portals as search results, the system enables the user to enter the first simulated space 820 via the first portal 810, using a personal mobile computing device 710. While the user is in the first simulated space 820, the augmented reality search engine system enables the user to interact with virtual objects 880 in the first simulated space 820, using a personal mobile computing device 710. Additionally, the augmented reality search engine system also enables the user to interact with virtual people 890 and/or other users in the first simulated space 820, using a personal mobile computing device 710. Additionally, the augmented reality search engine system enables the user to return from the first simulated space 820 via the first portal 810 back to the search results page 720, as shown in FIG. 7. In some embodiments, the augmented reality search engine system enables the user to directly access another of the other simulated spaces 920 or 1020 via additional portals within the first simulated space 820, without first returning to the search results page 720.

FIG. 9A illustrates a second portal 910 of the multiple portals provided as a search result of the augmented reality search engine system that is accessible by the user. The second portal 910 of the multiple portals provides an entrance to the second simulated space 820, which is a result search of the user search request 630 that was entered into the search bar 620 in FIG. 6. Inside the second simulated space 920 (through the portal 910), virtual items 980 such as virtual foods 980 are shown in the current embodiment. Additionally, inside the second simulated space 920 (through the portal 910), virtual people 990 are shown, which may be other users (i.e., avatars of other users), may be virtual non-user characters, or both, in the current embodiment.

In one or more embodiments, such as those disclosed in FIG. 9A, the second portal 810 may enable a user to look through the second portal 910 in the multi-dimensional fabric user interface and see the second simulated space 920 on the other side of the second portal 910, using a personal mobile computing device 710. Thus, in the embodiment shown in FIG. 9A, the user is able to look through the second portal 910 and see the virtual representation of the second search result 930 (i.e., the virtual representation of the physical space) in the second simulated space 920 on the other side of the second portal 910, using a personal mobile computing device 710. In still other embodiments, the user may not be able to initially see through the second portal 910 and see the virtual representation of the second search result 930 (i.e., the virtual representation of the physical space) in the second simulated space 920 on the other side of the second portal 910 until after the user takes a certain action or initiates a certain operation to cause the second portal 910 to become open as a viewing port.

Moreover, in one or more embodiments, the augmented reality search engine system for providing multiple portals as search results in a multi-dimensional fabric user interface enables the user to look through the second portal 910 associated with the second search result 930, as shown in FIG. 9A, and see a virtual person 990 or another user in the second simulated space 920, which is a virtual representation of physical space associated with the second search result 930 in the multi-dimensional fabric user interface. In some such embodiments, the augmented reality search engine system enables the user to look through the second portal 910 associated with the second search result 930 and interact with one or more virtual persons 990 (potentially including other users), virtual objects 980, virtual locations, or virtual events in the second simulated space 920 associated with the second search result 930, while still remaining on the search results page 720. Such interaction through the second portal 910 is similar to the action of a customer interacting with a vender through a service window. These interactions include by way of example only, and not by way of limitation: uploading data, downloading data, posting data, live streaming data, purchasing a product or service, selling a product or service, anchoring digital content to the multi-dimensional fabric, and modifying previously anchored digital content on the multi-dimensional fabric.

FIG. 9B illustrates a second simulated space 920 accessed through the second portal 910 of multiple portals that is associated with the second search result 930 by the searcher. Referring now to FIG. 9B, in some aspects of the augmented reality search engine system for providing multiple portals as search results, the system enables the user to enter the second simulated space 920 via the second portal 910, using a personal mobile computing device 710. While the user is in the second simulated space 920, the augmented reality search engine system enables the user to interact with virtual objects 980 in the second simulated space 920, using a personal mobile computing device 710. Additionally, the augmented reality search engine system also enables the user to interact with virtual people 990 and/or other users in the second simulated space 920, using a personal mobile computing device 710. Additionally, the augmented reality search engine system enables the user to return from the second simulated space 920 via the second portal 910 back to the search results page 720, as shown in FIG. 7. In some embodiments, the augmented reality search engine system enables the user to directly access another of the other simulated spaces 820 or 1020 via additional portals within the second simulated space 920, without first returning to the search results page 720.

FIG. 10A illustrates a third portal 1010 of the multiple portals provided as a search result of the augmented reality search engine system that is accessible by the user. The third portal 1010 of the multiple portals provides an entrance to the third simulated space 1020, which is a result search of the user search request 630 that was entered into the search bar 620 in FIG. 6. Inside the third simulated space 1020 (through the portal 1010), virtual items 1080 such as virtual foods 1080 are shown in the current embodiment. Additionally, inside the third simulated space 1020 (through the portal 1010), virtual people 1090 are shown, which may be other users (i.e., avatars of other users), may be virtual non-user characters, or both, in the current embodiment.

In one or more embodiments, such as those disclosed in FIG. 10A, the third portal 1010 may enable a user to look through the third portal 1010 in the multi-dimensional fabric user interface and see the third simulated space 1020 on the other side of the third portal 1010, using a personal mobile computing device 710. Thus, in the embodiment shown in FIG. 10A, the user is able to look through the third portal 1010 and see the virtual representation of the third search result 1030 (i.e., the virtual representation of the physical space) in the third simulated space 1020 on the other side of the third portal 1010, using a personal mobile computing device 710. In still other embodiments, the user may not be able to initially see through the third portal 1010 and see the virtual representation of the third search result 1030 (i.e., the virtual representation of the physical space) in the third simulated space 1020 on the other side of the third portal 1010 until after the user takes a certain action or initiates a certain operation to cause the third portal 1010 to become open as a viewing port.

Moreover, in one or more embodiments, the augmented reality search engine system for providing multiple portals as search results in a multi-dimensional fabric user interface enables the user to look through the third portal 1010 associated with the third search result 1030, as shown in FIG. 10A, and see a virtual person 1090 or another user in the third simulated space 1020, which is a virtual representation of physical space associated with the third search result 1030 in the multi-dimensional fabric user interface. In some such embodiments, the augmented reality search engine system enables the user to look through the third portal 1010 associated with the third search result 1030 and interact with one or more virtual persons 1090 (potentially including other users), virtual objects 1080, virtual locations, or virtual events in the third simulated space 1020 associated with the third search result 1030, while still remaining on the search results page 720. Such interaction through the third portal 1010 is similar to the action of a customer interacting with a vender through a service window. These interactions include by way of example only, and not by way of limitation: uploading data, downloading data, posting data, live streaming data, purchasing a product or service, selling a product or service, anchoring digital content to the multi-dimensional fabric, and modifying previously anchored digital content on the multi-dimensional fabric.

FIG. 10B illustrates a third simulated space 1020 accessed through the third portal 1010 of multiple portals that is associated with the third search result 1030 by the searcher. Referring now to FIG. 10B, in some aspects of the augmented reality search engine system for providing multiple portals as search results, the system enables the user to enter the third simulated space 1020 via the third portal 1010, using a personal mobile computing device 710. While the user is in the third simulated space 1020, the augmented reality search engine system enables the user to interact with virtual objects 1080 in the third simulated space 1020, using a personal mobile computing device 710. Additionally, the augmented reality search engine system also enables the user to interact with virtual people 1090 and/or other users in the third simulated space 1020, using a personal mobile computing device 710. Additionally, the augmented reality search engine system enables the user to return from the third simulated space 1020 via the third portal 1010 back to the search results page 720, as shown in FIG. 7. In some embodiments, the augmented reality search engine system enables the user to directly access another of the other simulated spaces 820 or 920 via additional portals within the third simulated space 1020, without first returning to the search results page 720.

In other embodiments of the augmented reality search engine system, four virtual portals, five virtual portals, ten virtual portals, one hundred virtual portals, two hundred virtual portals, a thousand virtual portals, or any intervening number of virtual portals are shown as search results, with corresponding simulated spaces and associated search results.

In one or more implementations, the augmented reality search engine system enables the user to create an additional portal (not shown) within one or more of the simulated spaces 820, 920, and 1020. The additional portal may be accessed by a processor-based computing device, such as a computer, smartphone, smartwatch, wearable VR headset, wearable AR headset, or the like, such as the personal mobile computing devices 710 or display devices 108a, 108b, and 108c, shown in FIG. 1. In some implementations, the additional portal operates to create an exit from the simulated spaces 820, 920, and 1020 back to the search results page 720. In other implementations, the additional portal operates to create a subspace within the simulated spaces 820, 920, and 1020, which may further be entered by the user (e.g., a sub-simulated space within the simulated spaces 820, 920, and 1020). In some implementations of the augmented reality search engine system, the simulated spaces 820, 920, and 1020 are virtual reality simulated spaces, while in other embodiments of the augmented reality search engine system, the simulated spaces 820, 920, and 1020 are augmented reality simulated spaces.

In some embodiments of the augmented reality search engine system, the system further enables the user to control parameters within the simulated spaces 820, 920, and 1020 that are accessed by the portals 810, 910, and 1010. For example, one of the parameters within the simulated spaces 820, 920, and 1020 that is controllable by the user is time. In this manner, in some embodiments the user can speed up and/or slow down a rate at which time passes. In other aspects of this parameter control within the simulated space, the user is able to control parameters such as spatial proximity, height/width/depth of virtual objects 880, 980, 1080 within the simulated spaces 820, 920, and 1020, gravity within the simulated spaces 820, 920, and 1020, the appearance of virtual people 890, 990, and 1090 and/or other users (e.g., make the virtual people 890, 990, and 1090 and/or other users older, younger, taller, shorter, more attractive, less attractive, shape-shift into other people, animals, or objects), the appearance of virtual objects 880, 980, 1080 and the like. In still other aspects of the parameter control within the simulated space, the user is able to enhance his avatar within the simulated space with superhero type abilities, (e.g., super strength, super speed, super hearing, flight, telekinesis, and the like).

Additionally, the augmented reality search engine system may also enable the user to load one or more simulated objects 880, 980, 1080 and/or one or more virtual people 890, 990, and 1090 into the simulated spaces 820, 920, and 1020 (shown in FIGS. 8B, 9B, and 10B). In some embodiments of the augmented reality search engine system for providing multiple portals as search results, the one or more simulated objects 880, 980, 1080 and/or one or more virtual people 890, 990, and 1090 loaded into the simulated spaces 820, 920, and 1020 had their images and measurements captured using the hardware sensor array 510. However, in other embodiments, the one or more simulated objects 880, 980, 1080 and/or one or more virtual people 890, 990, and 1090 are loaded into the simulated spaces 820, 920, and 1020 without using the hardware sensor array 510, e.g., by having the images and measurements transferred from another server or by having the images and measurements be computer generated. Notably, in some embodiments, the augmented reality search engine system for providing multiple portals as search results enables the user to position the additional portals anywhere in the simulated spaces 820, 920, and 1020.

Various embodiments, of the multi-dimensional fabric described herein can be used for a variety of different content storage technologies. Some example technology is the fluid timeline social network described in U.S. patent application Ser. No. 16/300,028, filed Nov. 8, 2018, titled FLUID TIMELINE SOCIAL NETWORK, and issued Aug. 18, 2020, as U.S. Pat. No. 10,747,414, and the portal social network described in U.S. patent application Ser. No. 17/751,477, filed May 24, 2022, titled SYSTEM AND METHOD FOR USING PORTAL SYSTEMS IN AUGMENTED REALITY VIRTUAL ENVIRONMENTS, which are incorporated herein by reference.

In another aspect of the augmented reality search engine system, once the user is inside the portal 710, the user may use “pinch” and “zoom” gesturing with two or more fingers interfacing with the screen of the personal mobile computing device to bring digital content closer to them (e.g., pinching) or further from them (e.g., zooming). In still another embodiment, a user may upload any augmented reality scenery into the multi-dimensional fabric user interface that is desired (e.g., a space based theoretical physical location, a past actual physical location that no longer exists, an anticipated future physical location that has not yet been built, and the like).

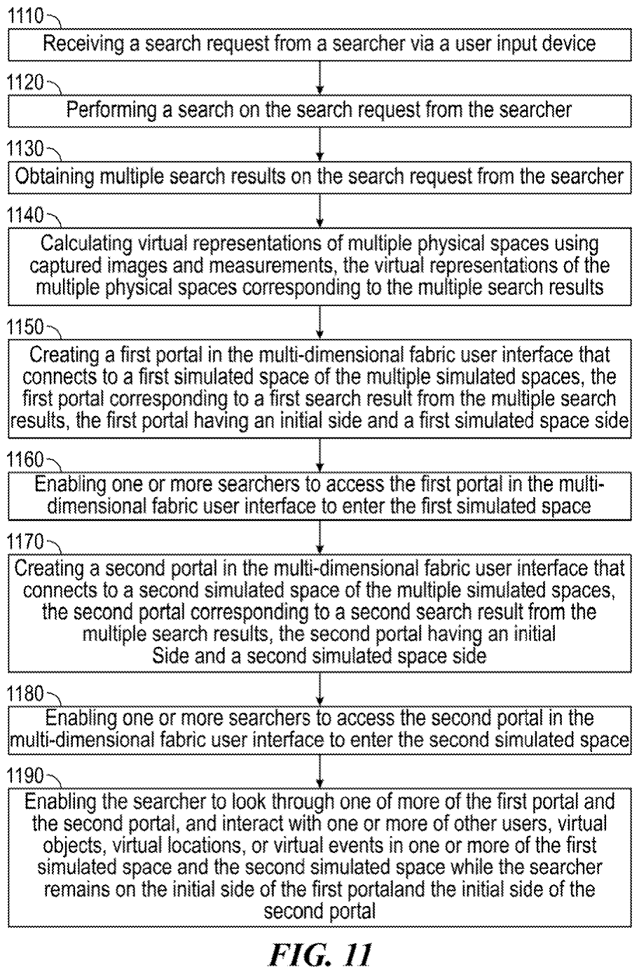

FIG. 11 is a logic diagram showing an augmented reality search engine method for providing multiple portals as search results in a multi-dimensional fabric user interface. As shown in FIG. 11, at operation 1110, the method includes receiving a search request 630 from a searcher via a user input device. At operation 1120, the method includes performing a search on the search request 630 from the searcher. At operation 1130, the method includes obtaining multiple search results 830, 930, and 1030 on the search request 630 from the searcher. At operation 1140, the method includes calculating virtual representations of multiple physical spaces using captured images and measurements, the virtual representations of the multiple physical spaces corresponding to the multiple search results 830, 930, and 1030. At operation 1150, the method includes creating a first portal 810 in the multi-dimensional fabric user interface that connects to a first simulated space 820 of the multiple simulated spaces, the first portal 810 corresponding to a first search result 830 from the multiple search results, the first portal having an initial side and a first simulated space side. At operation 1160, the method includes enabling one or more searchers to access the first portal 810 in the multi-dimensional fabric user interface to enter the first simulated space 820. At operation 1170, the method includes creating a second portal 910 in the multi-dimensional fabric user interface that connects to a second simulated space 920 of the multiple simulated spaces, the second portal 910 corresponding to a second search result 930 from the multiple search results, the second portal 910 having an initial side and a second simulated space side. At operation 1180, the method includes enabling one or more searchers to access the second portal 910 in the multi-dimensional fabric user interface to enter the second simulated space 920. At operation 1190, the method includes enabling the searcher to look through one or more of the first portal 810 and the second portal 910, and interact with one or more other users 890, 990, virtual objects 880, 980, virtual locations, or virtual events in one or more of the first simulated space 810 and the second simulated space 910 while the searcher remains on the initial side of the first portal 810 and the initial side of the second portal 910, i.e., the search results page 720.

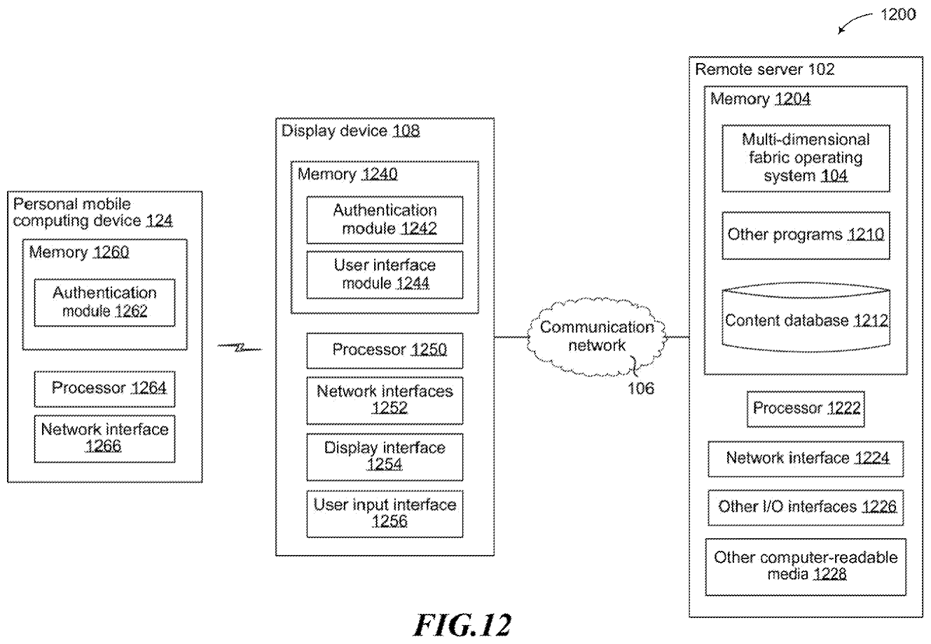

FIG. 12 shows a system diagram that describes one implementation of computing systems 1200 for implementing embodiments described herein for an augmented reality search engine system that provides multiple portals as search results, and which can perform the process set forth in FIG. 11. System 1200 includes remote server 102, one or more display devices 108, and one or more personal mobile computing devices 124, which display the portals shown in FIGS. 6-10.

As described herein, the remote server 102 is a computing device that can perform functionality described herein for implementing an operating system that provides a multi-dimensional fabric user interface for storing content. One or more special purpose computing systems may be used to implement the remote server 102. Accordingly, various embodiments described herein may be implemented in software, hardware, firmware, or in some combination thereof. The remote server 102 includes memory 1204, one or more processors 1222, network interface 1224, other input/output (I/O) interfaces 1226, and other computer-readable media 1228. In some embodiments, the remote server 102 may be implemented by cloud computing resources.

Processor 1222 includes one or more processing devices that execute computer instructions to perform actions, including at least some embodiments described herein. In various embodiments, the processor 1222 may include one or more central processing units (CPU), programmable logic, or other processing circuitry.

Memory 1204 may include one or more various types of non-volatile and/or volatile storage technologies. Examples of memory 1204 include, but are not limited to, flash memory, hard disk drives, optical drives, solid-state drives, various types of random-access memory (RAM), various types of read-only memory (ROM), other computer-readable storage media (also referred to as processor-readable storage media), or other memory technologies, or any combination thereof. Memory 1204 may be utilized to store information, including computer-readable instructions that are utilized by processor 1222 to perform actions, including at least some embodiments described herein.

Memory 1204 may have stored thereon multi-dimensional fabric operating system 104. The multi-dimensional fabric operating system 104 authenticates users of personal mobile computing devices 124 via display devices 108 and provides a user interface of a multi-dimensional fabric for storing and accessing content, as described herein.

Memory 1204 may include a content database 1212 for storing content in accordance with the multi-dimensional fabric user interface. Memory 1204 may also store other programs 1210. The other programs 510 may include other operating systems, user applications, or other computer programs that are accessible to the personal mobile computing device 124 via the display device 108.

Network interface 1224 is configured to communicate with other computing devices, such as the display devices 108, via a communication network 106. Network interface 1224 includes transmitters and receivers (not illustrated) to send and receive data associated with the multi-dimensional fabric user interface described herein.

Other I/O interfaces 1226 may include interfaces for various other input or output devices, such as audio interfaces, other video interfaces, USB interfaces, physical buttons, keyboards, haptic interfaces, tactile interfaces, or the like. Other computer-readable media 1228 may include other types of stationary or removable computer-readable media, such as removable flash drives, external hard drives, or the like.

The display devices 108 are computing devices that are remote from the remote server 102. In some embodiments, the display devices 108 may include one or more computing devices and display devices. The display devices 108 coordinate authentication between the personal mobile computing devices 124 and the remote server 102. The display devices 108 receive input from the users of the personal mobile computing device 124 and provide the input to the remote server 102. The display devices 108 receive the graphical user interfaces for the multi-dimensional fabric user interface to be presented to the users of the personal mobile computing devices 124.

One or more special-purpose computing systems may be used to implement the display devices 108. Accordingly, various embodiments described herein may be implemented in software, hardware, firmware, or in some combination thereof.

The display devices 108 include memory 1240, one or more processors 1250, network interface 1252, display interface 1254, and user input interface 1256. The memory 1240, processor 1250, and network interface 1252 may be similar to, include similar components, or incorporate embodiments of memory 1204, processor 1222, and network interface 1224 of remote server 102, respectively. Thus, processor 1250 includes one or more processing devices that execute computer instructions to perform actions, including at least some embodiments described herein. In various embodiments, the processor 1250 may include one or more CPUs, programmable logic, or other processing circuitry. The network interfaces 1252 are also configured to communicate with the personal mobile computing devices 124, such as via Bluetooth or other short-range communication protocol or technology.

Memory 1240 may include one or more various types of non-volatile and/or volatile storage technologies. Memory 1240 may be utilized to store information, including computer-readable instructions that are utilized by processor 1250 to perform actions, including at least some embodiments described herein. Memory 1240 may store various modules or programs, including authentication module 1242 and user interface module 1244. The authentication module 1242 may perform actions that coordinate the authentication between the personal mobile computing devices 124 and the remote server 102. The user interface module 1244 receives graphical user interface data from the remote server 102 for display or presentation, via the display interface 1254, to the user of the personal mobile computing devices 124. The user interface module 1244 also receives user input via the user input interface 1256 and provides that input back to the remote server 102. In various embodiments, one or more capacitive, radar, infrared, LIDAR, or other type of gesture capturing sensors may be used to receive the user input. In some other embodiments, the user interface module 1244 may receive user inputs via other input mechanisms, such as a mouse, stylus, voice-recognition, or other input sensors. Memory 1240 may also store other programs.

The personal mobile computing devices 124 are computing devices that are remote from the display devices 108 and the remote server 102. When a personal mobile computing device 124 is within a threshold range of the display device 108 or when a user of the personal mobile computing device 124 activates authentication, the personal mobile computing device 124 provides authentication data or information to the display device 108 for forwarding to the remote server 102. In various embodiments, the personal mobile computing device 124 is separate from the display device 108, such that a user can walk up to a display device 108 with the personal mobile computing device 124 to initiate the process described herein to have the display device 108 present the user interface of the multi-dimensional fabric received from the remote server 102. The user can then provide input to the display device 108, such as with hand gestures or arm movement, to manipulate the multi-dimensional fabric user interface and select content for display.

One or more special-purpose computing systems may be used to implement the personal mobile computing devices 124. Accordingly, various embodiments described herein may be implemented in software, hardware, firmware, or in some combination thereof.

The personal mobile computing devices 124 include memory 1260, one or more processors 1264, and a network interface 1266. The memory 1260, processor 1264, and network interface 1266 may be similar to, include similar components, or incorporate embodiments of memory 1240, processor 1250, and network interfaces 1252 of display devices 108, respectively. Thus, processor 1264 includes one or more processing devices that execute computer instructions to perform actions, including at least some embodiments described herein. In various embodiments, the processor 1264 may include one or more CPUs, programmable logic, or other processing circuitry. The network interface 1266 is configured to communicate with the display devices 108, but not with the remote server 102.

Memory 1260 may include one or more various types of non-volatile and/or volatile storage technologies. Memory 1260 may be utilized to store information, including computer-readable instructions that are utilized by processor 1266 to perform actions, including at least some embodiments described herein. Memory 1260 may store various modules or programs, including authentication module 1262. The authentication module 1262 may perform actions to communicate authentication information to a display device 108 when within a threshold distance from the display device or when activated by a user.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A system for providing augmented reality virtual portals as search results that are accessible to searchers, the system comprising:
a remote server that includes a server memory that stores server computer instructions and a server processor that when executing the server computer instructions causes the remote server to:
receive a search request from a searcher via a user input device;
perform a search on the search request from the searcher;
obtain multiple search results on the search request from the searcher;
calculate virtual representations of multiple physical spaces using captured images and measurements, the virtual representations of the multiple physical spaces corresponding to the multiple search results;
create a first portal in a multi-dimensional fabric user interface that connects to a first simulated space of multiple simulated spaces, the first portal corresponding to a first search result from the multiple search results, the first portal having an initial side and a first simulated space side;
enable the searcher to access the first portal in the multi-dimensional fabric user interface to access the first simulated space;
create a second portal in the multi-dimensional fabric user interface that connects to a second simulated space of the multiple simulated spaces, the second portal corresponding to a second search result from the multiple search results, the second portal having an initial side and a second simulated space side;
enable the searcher to access the second portal in the multi-dimensional fabric user interface to access the second simulated space; and
enable the searcher to look through one or more of the first portal and the second portal, and interact with one or more other users, virtual objects, virtual locations, or virtual events in one or more of the first simulated space and the second simulated space while the searcher remains on the initial side of the first portal and the initial side of the second portal.

2. The system of claim 1, wherein the server processor executes further server computer instructions that further cause the remote server to:
create a third portal in the multi-dimensional fabric user interface that connects to a third simulated space of the multiple simulated spaces, the third portal corresponding to a third search result from the multiple search results, the third portal having an initial side and a second simulated space side;
enable the searcher to access the third portal in the multi-dimensional fabric user interface to access the third simulated space; and
enable the searcher to look through the third portal, and interact with one or more other users, virtual objects, virtual locations, or virtual events in the third simulated space while the searcher remains on the initial side of the third portal and the initial side of the second portal.

3. The system of claim 1, wherein the server processor executes further server computer instructions that further cause the remote server to:
enable the searcher to enter the first portal and travel to the first simulated space from the multi-dimensional fabric user interface and enter the second portal and travel to the second simulated space from the multi-dimensional fabric user interface.

4. The system of claim 1, wherein the server processor executes further server computer instructions that further cause the remote server to:
while in the first simulated space, enable the searcher to interact with one or more other users, virtual objects, virtual locations, or virtual events in the first simulated space.

5. The system of claim 1, wherein the captured images and measurements of a physical space is captured by one or more hardware sensor arrays, wherein the one or more hardware sensor arrays uses LIDAR to capture one or more flat images and images with depth resolution.

6. The system of claim 1, wherein the server processor executes further server computer instructions that further cause the remote server to enable the searcher to control parameters within the simulated space.

7. The system of claim 6, wherein one of the parameters within the simulated space that is controllable by the searcher is time, and wherein the searcher can speed up or slow down a rate at which time passes.

8. The system of claim 1, wherein the remote server when executing the server computer instructions further causes the remote server to:
enable the searcher to move from the first simulated space to the second simulated space through an additional portal.

9. A method for providing augmented reality virtual portals as search results that are accessible to searchers, the method comprising:
receiving a search request from a searcher via a user input device;
performing a search on the search request from the searcher;
obtaining multiple search results on the search request from the searcher;
calculating virtual representations of multiple physical spaces using captured images and measurements, the virtual representations of the multiple physical spaces corresponding to the multiple search results;
creating a first portal in a multi-dimensional fabric user interface that connects to a first simulated space of multiple simulated spaces, the first portal corresponding to a first search result from the multiple search results, the first portal having an initial side and a first simulated space side;
enabling the searcher to access the first portal in the multi-dimensional fabric user interface to enter the first simulated space;
enabling the searcher to look through the first portal and interact with one or more other users, virtual objects, virtual locations, or virtual events in one or more of the first simulated space while the searcher remains on the initial side of the first portal.

10. The method of claim 9, further comprising:
creating a second portal in the multi-dimensional fabric user interface that connects to a second simulated space of the multiple simulated spaces, the second portal corresponding to a second search result from the multiple search results, the second portal having an initial side and a second simulated space side;
enabling the searcher to access the second portal in the multi-dimensional fabric user interface to access the second simulated space; and
enabling the searcher to look through the second portal, and interact with one or more other users, virtual objects, virtual locations, or virtual events in the second simulated space while the searcher remains on the initial side of the second portal and the initial side of the second portal.

11. The method of claim 10, further comprising:
enabling the searcher to enter the first portal and travel to the first simulated space from the multi-dimensional fabric user interface and enter the second portal and travel to the second simulated space from the multi-dimensional fabric user interface.

12. The method of claim 10, further comprising:
while in the first simulated space or the second simulated space, enabling the searcher to interact with one or more other users, virtual objects, virtual locations, or virtual events in the first simulated space or the second simulated space.

13. The method of claim 9, wherein the captured images and measurements of a physical space is captured by one or more hardware sensor arrays, wherein the one or more hardware sensor arrays uses LIDAR to capture one or more flat images and images with depth resolution.

14. The method of claim 9, further comprising enabling the searcher to control parameters within the simulated space.

15. The method of claim 14, wherein one of the parameters within the simulated space that is controllable by the searcher is time, and wherein the searcher can speed up or slow down a rate at which time passes.

16. The method of claim 9, further comprising: enabling the searcher to move from the first simulated space to the second simulated space through an additional portal.

17. A system for providing augmented reality virtual portals as search results that are accessible to searchers, the system comprising:
a remote server that includes a server memory that stores server computer instructions and a server processor that when executing the server computer instructions causes the remote server to:
receive a search request from the searcher via a user input device;
perform a search on the search request from the searcher;
obtain multiple search results on the search request from the searcher;
calculate virtual representations of multiple physical spaces using captured images and measurements, the virtual representations of the multiple physical spaces corresponding to the multiple search results;
create a first portal in a multi-dimensional fabric user interface that connects to a first simulated space of multiple simulated spaces, the first portal corresponding to a first search result from the multiple search results;
enable the searcher to access the first portal in the multi-dimensional fabric user interface to enter the first simulated space; and
enable the searcher to pass through the first portal into the first simulated space that corresponds to the first search result from the multiple search results.

18. The system of claim 17, wherein the server processor executes further server computer instructions that further cause the remote server to:
create a second portal in the multi-dimensional fabric user interface that connects to a second simulated space of the multiple simulated spaces, the second portal corresponding to a second search result from the multiple search results; and
enable the searcher to pass through the second portal in the multi-dimensional fabric user interface to the second simulated space that corresponds to the second search result from the multiple search results.

19. The system of claim 17, wherein the server processor executes further server computer instructions that further cause the remote server to:
while in the first simulated space or the second simulated space, enable the searcher to interact with one or more other users, virtual objects, virtual locations, or virtual events in the first simulated space or the second simulated space.

20. The system of claim 17, wherein the remote server when executing the server computer instructions further causes the remote server to:
enable the searcher to move from the first simulated space to the second simulated space through an additional portal.

21. A method for providing augmented reality virtual portals as search results that are accessible to searchers, the method comprising:
receiving a search request from the searcher via a user input device;
performing a search on the search request from the searcher;
obtaining multiple search results on the search request from the searcher;
calculating virtual representations of multiple physical spaces using captured images and measurements, the virtual representations of the multiple physical spaces corresponding to the multiple search results;
creating one or more portals in a multi-dimensional fabric user interface that connects to one or more simulated spaces of multiple simulated spaces, the one or more portals corresponding to one or more search results from the multiple search results, the one or more portals having an initial side and a simulated space side;
enabling the searcher to access the one or more portals in the multi-dimensional fabric user interface to enter the one or more simulated spaces; and
enable the searcher to pass through the one or more portals into the one or more simulated spaces that corresponds to the one or more search results from the multiple search results.

22. The method of claim 21, further comprising:
while in the one or more simulated spaces, enabling the searcher to interact with one or more other users, virtual objects, virtual locations, or virtual events in the one or more simulated spaces.

23. The method of claim 21, further comprising: enabling the searcher to move from a first simulated space of the one or more simulated spaces to a second simulated space of the one or more simulated spaces through an additional portal.
